(19) United States
(12) Patent Application Publication
(10) Pub. No.: US 2017/0349766 A1
(43) Pub. Date: Dec. 7, 2017

(54) OPACIFYING COMPOSITIONS FOR PVC FILMS

(71) Applicant: Avery Dennison Corporation, Glendale, CA (US)

(72) Inventors: Paul R. KLICH, Lyndhurst, OH (US); Anil Vilas GAIKWAD, Willoughby, OH (US)

(21) Appl. No.: 15/608,793

(22) Filed: May 30, 2017

Related U.S. Application Data
(60) Provisional application No. 62/344,617, filed on Jun. 2, 2016.

(51) Int. Cl. C09D 7/12; B05D 3/02; C09D 7/00; C09D 5/00; B05D 5/00; B05D 7/04; C08J 7/04; C09D 175/06; C09D 157/10; C08K 9/10; C08K 3/22; C08K 3/26

(52) U.S. Cl. CPC C09D 7/1216; C09D 175/06; B05D 3/0254; C09D 7/1291; C09D 7/001; C09D 5/00; C09D 157/10; B05D 5/00; B05D 7/04; C08J 7/047; C08K 3/22; C08J 2475/06; C08J 2457/10; C08J 2327/06; C08K 3/26; C08K 9/10; C08K 2003/2241; C08K 2003/265

(57) ABSTRACT

Various coating compositions are described which provide protection for polymeric films and particularly PVC films. The coating compositions include particular resin(s) and opacifying agents. Also described are coated films utilizing the compositions and methods of forming the coated films.

### CROSS REFERENCES TO RELATED APPLICATIONS

The present application claims priority upon U.S. provisional patent application Ser. No. 62/344,617 filed Jun. 2, 2016.

### FIELD

The present subject matter relates to coating compositions for application to polymeric films and particularly opacifying coatings for application to polyvinyl chloride (PVC) films.

### BACKGROUND

Coatings for films are well known. Such coatings are typically applied to form protective layers or to serve as primers or underlayers for subsequent deposition of one or more other layers.

Although satisfactory in many regards, a need remains for improved coated films and coatings which can be easily applied to polymeric films to provide a low cost alternative to currently known coated films. A need also exists for coatings that can provide superior or at least enhanced performance as compared to currently known films.

### SUMMARY

The difficulties and drawbacks associated with previous approaches are addressed in the present subject matter as follows.

In one aspect, the present subject matter provides a coating composition comprising at least one resin component and at least one opacifying agent. The resin component is selected from the group consisting of (i) polyvinyl acrylate copolymer with —COOH functionality having a Tg within a range of from 20° C. to 80° C., (ii) polyvinyl acrylate copolymer with —OH functionality having a Tg within a range of from 20° C. to 80° C., (iii) polyester polyurethane having a softening point within a range of from 120° C. to 180° C., (iv) combination of polyvinyl acrylate copolymer with —COOH functionality with a Tg within a range of from 20° C. to 80° C. with acrylate(s) having a Tg within a range of from 20° C. to 80° C., (v) combination of polyvinyl acrylate copolymer with —OH functionality with a Tg within a range of from 20° C. to 80° C. with acrylate(s) having a Tg within a range of from 20° C. to 80° C., and (vi) acrylate(s) having a Tg within a range of from 20° C. to 80° C.

In another aspect, the present subject matter provides a method of producing a coated polymeric film. The method comprises providing a polymeric film to be coated. The method also comprises providing a coating composition including at least one resin component, at least one solvent, and at least one opacifying agent. The resin component is selected from the group consisting of (i) polyvinyl acrylate copolymer with —COOH functionality having a Tg within a range of from 20° C. to 80° C., (ii) polyvinyl acrylate copolymer with —OH functionality having a Tg within a range of from 20° C. to 80° C., (iii) polyester polyurethane having a softening point within a range of from 120° C. to 180° C., (iv) combination of polyvinyl acrylate copolymer with —COOH functionality with a Tg within a range of from 20° C. to 80° C. with acrylate(s) having a Tg within a range of from 20° C. to 80° C., (v) combination of polyvinyl acrylate copolymer with —OH functionality with a Tg within a range of from 20° C. to 80° C. with acrylate(s) having a Tg within a range of from 20° C. to 80° C., and (vi) acrylate(s) having a Tg within a range of from 20° C. to 80° C. The method also comprises applying the coating composition to the film. And, the method comprises drying the applied coating composition to thereby produce a coated polymeric film.

In still another aspect, the present subject matter provides a coated substrate comprising a substrate, and a layer of a coating composition disposed on the substrate. The coating composition includes at least one resin component and at least one opacifying agent, the resin component selected from the group consisting of (i) polyvinyl acrylate copolymer with —COOH functionality having a Tg within a range of from 20° C. to 80° C., (ii) polyvinyl acrylate copolymer with —OH functionality having a Tg within a range of from 20° C. to 80° C., (iii) polyester polyurethane having a softening point within a range of from 120° C. to 180° C., (iv) combination of polyvinyl acrylate copolymer with —COOH functionality with a Tg within a range of from 20° C. to 80° C. with acrylate(s) having a Tg within a range of from 20° C. to 80° C., (v) combination of polyvinyl acrylate copolymer with —OH functionality with a Tg within a range of from 20° C. to 80° C. with acrylate(s) having a Tg within a range of from 20° C. to 80° C., and (vi) acrylate(s) having a Tg within a range of from 20° C. to 80° C.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a schematic cross section of a coated substrate in an embodiment of the present subject matter.

FIG. 2 is a schematic cross section of a coated substrate in another embodiment of the present subject matter.

FIG. 3 is a schematic cross section of a coated substrate in another embodiment of the present subject matter.

### DETAILED DESCRIPTION OF THE EMBODIMENTS

The present subject matter relates to coating compositions that are highly opaque, i.e., greater than 95%, which are durable and resistant to UV radiation, weather resistant, exhibit excellent adhesion to PVC, and which are flexible and not prone to cracking.

Various opacity values are described herein. Opacity can be measured directly by a contrast ratio formula. Contrast ratio can be measured by various instruments and has been defined by ASTM in Test Method D2805 (Standard Test Method for Hiding Power by Reflectometry) that uses spectrophotometric instrumentation to assess contrast ratios and provide opacity values. A completely opaque layer or coating blocks all light transmission and thus has an opacity value of 100%.

### Compositions

Generally, the coating compositions comprise one or more resin components, one or more opacifying agents, one or more solvents, and optionally, one or more processing agents. Each of these components and agents are as follows.

### Resin Component(s)

In one embodiment, the resin component comprises one or more polyvinyl acrylate copolymer(s) with —COOH functionality having a glass transition temperature (Tg) within a range of from 20° C. to 80° C., and particularly from 65° C. to 80° C.

In another embodiment, the resin component comprises one or more polyvinyl acrylate copolymer(s) with —OH functionality having a Tg within a range of from 20° C. to 80° C., and particularly from 65° C. to 80° C.

In another embodiment, the resin component comprises one or more polyester polyurethane(s) having a softening point within a range of from 120° C. to 180° C.

In another embodiment, the resin component comprises a combination of polyvinyl acrylate copolymer(s) with —COOH functionality with acrylate(s) having a Tg within a range of from 20° C. to 80° C., and in particular about 65° C. The polyvinyl acrylate copolymer has a Tg within a range of from 20° C. to 80° C. and particularly from 65° C. to 80° C. The weight ratio of polyvinyl acrylate copolymer(s) to acrylate(s) is within a range of from 20% to 80%, and particularly from 30% to 70%. The weight ratios expressed in percentages are with respect to the amount of polyvinyl acrylate copolymer(s) to acrylate(s), respectively. Thus, for example a weight ratio of 25% refers to 25 g of polyvinyl acrylate copolymer(s) per 100 g of acrylate(s).

In another embodiment, the resin component comprises a combination of polyvinyl acrylate copolymer(s) with —OH functionality with acrylate(s) having a Tg within a range of from 20° C. to 80° C., and in particular about 65° C. The polyvinyl acrylate copolymer has a Tg within a range of from 20° C. to 80° C. and particularly from 65° C. to 80° C. The ratio of polyvinyl acrylate copolymer(s) to acrylate(s) is within a range of from 20% to 80%, and particularly from 30% to 70%.

In another embodiment, the resin component comprises acrylate(s) having a Tg within a range of from 20° C. to 80° C. and particularly from 35° C. to 65° C. In certain versions, acrylate(s) are exclusively used for the resin component.

### Opacifying Agent(s)

A wide array of particulate materials can potentially be utilized as opacifying agent(s) in the present subject matter.

In some embodiments, the opacifying agent(s) are titanium dioxide (TiO₂) having an average particle size within a range of from 300 nm to 8 microns. In certain embodiments, the TiO₂ particles have an average particle size within a range of from 500 nm to 1.5 micron. In particular versions, coated particles of TiO₂ or core-shell TiO₂ particles can be used which include outer coatings or shells that include silicon oxide and/or aluminum oxide.

In certain embodiments, TiO₂ materials obtained commercially can be used such as but not limited to KRONOS 2220, KRONOS 2300, DuPont R960, and others. The KRONOS materials are available from Krones International. The DuPont material is available from DuPont USA.

In certain embodiments, the present subject matter avoids, i.e., is free of, the use of TiO₂ produced by the sulfate process. In the sulfate process, ilmenite (FeTiO₃), a common iron/titanium oxide material is used. That material is treated with concentrated sulfuric acid (H₂SO₄) and the titanium oxygen sulfate (TiOSO₄) is selectively extracted and converted into titanium dioxide.

Ilmenite is treated (digested) with a 60% excess of concentrated sulfuric acid at a temperature around 100° C. The following reaction takes place:

FeTiO₃+2H₂SO₄→FeSO₄+TiOSO₄+2H₂O

In the next stage, the waste product iron(II)sulfate is removed. As FeSO₄ is not very soluble at low temperatures, the solution is cooled to around 15° C. and FeSO₄ crystallizes out. It can then be removed by filtration.

The remaining aqueous digestion products are heated to around 100° C. in order to hydrolyze the titanium oxygen sulfate.

TiOSO₄+(n+₁)H₂O→TiO₂.nH₂O+H₂SO₄

The hydrolysis stage of the sulfate process produces sulfuric acid waste and a precipitate gel containing hydrated titanium dioxide.

In the last stage, the hydrated titanium dioxide is heated in large rotary kilns to drive off the water and produce crystals of anatase or rutile (2 forms of titanium dioxide).

TiO₂.nH₂O→TiO₂+nH₂O

Water is removed at temperatures between 200° C.-300° C. Seed crystals are added to start the crystallization process. Depending on the final heating temperature (800° C.-850° C. or 900° C.-930° C.), either anatase or rutile is formed, respectively.

In many embodiments of the present subject matter, TiO₂ produced by the chloride process is utilized.

The chloride process requires purer ore or rutile which is a much rarer than ilmenite. The raw material must contain at least 70% rutile. Titanium dioxide is reduced with carbon and then oxidized again with chlorine.

TiO₂+C→Ti+CO₂

Ti+2Cl₂→TiCl₄

Liquid TiCl₄ is distilled off and converted back into TiO₂ in a pure oxygen flame or in plasma at temperatures of 1,200° C.-1,700° C. The majority of chlorine is recovered.

TiCl₄+O₂→TiO₂+2Cl₂

Other materials can be used in conjunction with or instead of TiO₂ such as for example calcium carbonate (CaCO₃).

### Solvent(s)

A wide array of solvents and solvent systems can be used in association with the coating compositions in accordance with the present subject matter. Representative nonlimiting examples of suitable solvents include various alkyl acetate solvents, ketone solvents, alcohol solvents, and benzene derivative solvents. Combinations of these along with other solvents can be used.

Nonlimiting examples of alkyl acetate solvents include ethyl acetate, n-propyl acetate, butyal acetate, n-butyl acetate, propylene glycol monomethyl ether acetate (commercially available under the designation PM ACETATE from Eastman), methoxypropyl acetate (MPA), and combinations thereof.

Nonlimiting examples of ketone solvents include methyl ethyl ketone (MEK).

Nonlimiting examples of alcohol solvents include isopropyl alcohol (IPA).

Nonlimiting examples of benzene derivative solvents include toluene, xylene, and combinations thereof.

In certain embodiments, certain solvent systems can be used that include particular solvents in particular proportions. Tables 1-3 set forth below present particular solvent systems for use in association with the present subject matter. All proportions noted in Tables 1-3 are weight proportions and based upon the total weight of the resulting coating composition in which the solvent system is incorporated.

TABLE 1
Solvent System A

| Component | Typical Proportion(s) (%) |
|---|---|
| Ethyl Acetate | 20-36 |
| n-Butyl Acetate | 18-30 |
| Toluene | 4-12 |
| PM Acetate (propylene glycol | 0.1-5.0 |
| monomethyl ether acetate) | |
| Xylene | 0.1-2.0 |

TABLE 2
Solvent System B

| Component | Typical Proportion(s) (%) |
|---|---|
| Isopropyl Alcohol | 20-45 |
| Toluene | 15-35 |
| PM Acetate (propylene glycol | 0.1-5.0 |
| monomethyl ether acetate) | |
| Xylene | 0.1-2.0 |

TABLE 3
Solvent System C

| Component | Typical Proportion(s) (%) |
|---|---|
| n-Propyl Acetate | 15-28 |
| n-Butyl Acetate | 15-28 |
| Toluene | 5-15 |
| PM Acetate (propylene glycol | 0.1-5.0 |
| monomethyl ether acetate) | |
| Xylene | 0.1-2.0 |

### Processing Agents

The coating compositions of the present subject matter may optionally include one or more processing agents. Representative nonlimiting examples of such agents include dispersants, wetting agents, thickening agents, and in particular acrylate based and/or silicone based thickening agents, drying aids and in particular amine based and/or low boiling solvent based drying aids, and combinations thereof.

In many embodiments, if one or more processing agents are used, the total weight amount of the agents is within a range of from 0.05% to 2.0%.

### Methods

The various coating compositions of the present subject matter can be prepared using conventional mixing and blending techniques and equipment.

Incorporation of solvent or a solvent system into the coating composition depends upon several factors including coating method(s) and desired properties of the intermediate coated film(s) and final coated film product(s). However, in many applications beneficial results stem from the use of a majority weight proportion of solvent(s) used with a minority weight proportion of coating component(s). For example, in many applications, the total weight of the coating is within a range of from 30% to 50%, and the total weight of solvent(s) is within a range of from 70% to 50%. It will be appreciated that the present subject matter is not limited to these weight proportions and includes the use of greater or lesser amounts of coating solids and/or solvent(s).

After incorporating desired or suitable amounts of solvent in the coating composition, the composition is applied to a surface of interest such as a polymeric film face and in particular to a PVC film face. A wide array of application techniques can be utilized.

After application of the coating with solvent(s), the coating is typically subjected to one or more drying operations to remove solvent and produce a dried and protective coating on the film. In many embodiments, drying is performed at atmospheric pressure at a temperature within a range of from 200° F. (93° C.) to 300° F. (149° C.). However, it will be understood that temperatures outside of this range can be used so long as the resulting coating and/or film is not degraded or otherwise detrimentally impacted. Drying can also be performed at sub-atmospheric pressures.

In particular embodiments, drying is performed to remove solvent from the coating composition and obtain a coating which contains less than 2.0% by weight of residual solvent. In many applications, solvent amounts greater than 2.0% in a coating lead to poor performance of the coating and/or coated film.

After drying, in many embodiments of the present subject matter, the dried coating weight is within a range of from 10 grams per square meter (gsm) to 25 gsm. In many applications, a coat weight of 15 gsm is used.

In many embodiments of the present subject matter, dried coatings or layers of the compositions described herein provide opacity levels greater than 80%, in certain embodiments greater than 85%, in certain embodiments greater than 90%, and in certain embodiments greater than 95%. In particular versions, the coatings exhibit opacity levels within a range such as from 90% to 99%. In particular versions of the present subject matter, the opacity levels of such coatings can be as high as 96%, 97%, 98%, and in certain instances 99% or greater.

In many embodiments, the coatings of the present subject matter exhibit excellent resistance to UV radiation and weather. In particular versions, the coatings successfully passed testing of 5,000 hours as defined in ASTM D4956, and/or 2,000 hours of Accelerated Weathering (QUV) as defined by ASTM G154.

In still other embodiments, coatings of the present subject matter successfully passed Accelerated Weather testing at 90° C. for 48 hours as determined by the previously noted G154 standard.

In yet other embodiments, coated films of the present subject matter, after being subjected to a stress relaxation test, exhibited stresses less than 1 pound. The stress relaxation test is a measurement of the extent to which a flexible film will either retain or dissipate tensile force induced during a tensile test. This test is designed to evaluate the relaxation of a film when it is stretched 13% for 12 minutes. The stress relaxation of plastic films is determined with a tensile tester. The test is restricted to plastic films and sheets with a thickness of less than 0.040 inches. Samples are secured in upper and lower clamps of the test instrument, then stretched to 13% and held for 12 minutes. This test measures the “memory” of the coated film. Specifically, a coated film sample having dimensions of 1 by 8 inches is placed within an elongation tensile tester such as an Instron Model 3345. The Instron is set to run the Stress Relaxation Test Method. Stretching of the sample is initiated. The elongation rate is 4 inches per minute. When the elongation of the sample reaches 13%, the Instron jaws stop and maintain their position for 12 minutes. Then, the jaws return to their initial position at a sample gauge length of 6 inches. The sample is removed and the minimum load reading or retained force (Fₘᵢₙ) in the sample is recorded.

In still further embodiments, the coatings can withstand corrugated conformability testing QUV of 1,000 hours. The corrugated conformability test is used to determine the suitability of a film coated with a pressure sensitive adhesive for use on a deep corrugation application. This method uses a 4 inch by 12 inch painted aluminum test panel with one or more corrugation channels to which a pressure sensitive coated film sample is applied via a heat gun and squeegee. Once applied, the sample is placed into an aging environment and monitored for lifting or loss of adhesion. Two samples are generally tested per material. Specifically, adhesive coated film samples having dimensions of 1 by 8 inches are adhered onto a clean corrugated panel. The samples extend into the valley and along opposite raised panel regions adjacent the valley. The adhered samples are then heated to a temperature and time sufficient to set the adhesive. The samples are then subjected to a 24 hour dwell period. Next, original edge lifting measurements are taken with a caliper. Lift in both machine direction and in cross direction are taken. Samples are then aged, typically for 1,000 hours in standard QUV with checks every 250 hours. During and/or after aging, lift is again measured. Failure occurs if delamination occurs after aging.

In particular embodiments, the coatings do not crack or delaminate from a substrate and in particular a PVC surface to which the coating was applied.

And in certain embodiments, the coatings exhibit long term removability from a substrate. Long term removability is determined by laminating a pressure sensitive adhesive film having one or more coating(s) to a surface and weathering the adhered film for various time periods, followed by removal from the surface typically accompanied with heating. Generally, panels for receiving the pressure sensitive films are painted or clear coated automotive panels and are prepared by cleaning typically by wiping with isopropyl alcohol and then drying. Film samples are cut and sized to provide a 1 inch overhang or pull tab upon adhering to the panels. The adhered films and panels are labeled and then placed into Xenon and QUV chambers as known in the art. Every 250 hours or other designated interval, the samples are inspected for any shrinkage, discoloration, adhesive ooze, or other undesirable factor(s). After a desired time period of testing, the samples are removed from the chambers and cooled to ambient temperature. The adhered film is then pulled from the panel by grasping of the tab. If the film does not separate or begins to tear, heat is then applied. A propane torch using a low setting can be used to heat the panel until warm to touch while avoiding over-heating which can cause delamination. Using a pull angle of slightly less than 90°, the film sample is then pulled from the panel. After removal, the panel is inspected for adhesive residue or “ghosting” as known in the art. Typically, a 7 year adhesive must remove cleanly after 2,000 hours in the Xenon chamber and 1,000 hours in the QUV. A 5 year adhesive must remove cleanly after approximately 1,000 hours in the Xenon and 500 hours in the QUV chambers.

A related evaluation is accelerated long term removability in which a pressure sensitive film having one or more coating(s) is laminated to a surface and then exposed to relatively high heat for 48 hours to promote full adhesive wet-out. After such exposure and return to ambient temperature, the film is removed from the surface with gentle heat if necessary. Samples of adhesive film are cut and applied to panels as previously described for long term removability. The adhered samples and panels are allowed to dwell for 24 hours prior to exposure to high heat. Then, the samples and panels are placed in an oven at 90° C. for 48 hours. After such heating, the adhered films are inspected for any shrinkage, discoloration, adhesive ooze, or other undesirable factor(s). After cooling to ambient temperature, the adhered film is then pulled from the panel. If the sample is not readily removed, then low heat is applied as previously described. After removal of the adhesive film, any adhesive residue is noted and any type of ghosting.

In many embodiments, the coating compositions are applied and then dried to form a dried coating. In these applications, the dried coatings are not crosslinked or substantially noncrosslinked. However, the present subject matter includes coatings that are crosslinked. Crosslinking can be achieved by known techniques such as, but not limited to, incorporation of one or more crosslinking agent(s), exposure to radiation, and/or heating to particular temperatures. In certain embodiments of the present subject matter, it may be desirable to crosslink the coating compositions to selectively adjust properties of the resulting coatings such as adhesion to the underlying film and/or durability of the coating.

### Coated Substrates

The present subject matter also provides substrates such as polymeric films and in particular polyvinyl chloride (PVC) films, that are coated with the coating compositions.

The polymeric films may include films of polyurethanes, polyethylenes, polypropylenes, polyesters, polyether esters, polyacrylates, polyvinyl chloride, and combinations thereof. It will be understood that the present subject matter includes the use of other polymeric materials and potentially in combination with one or more of the above noted polymeric materials. It will also be understood that the present subject matter also includes the use of substrates such as paper based materials and/or composite materials.

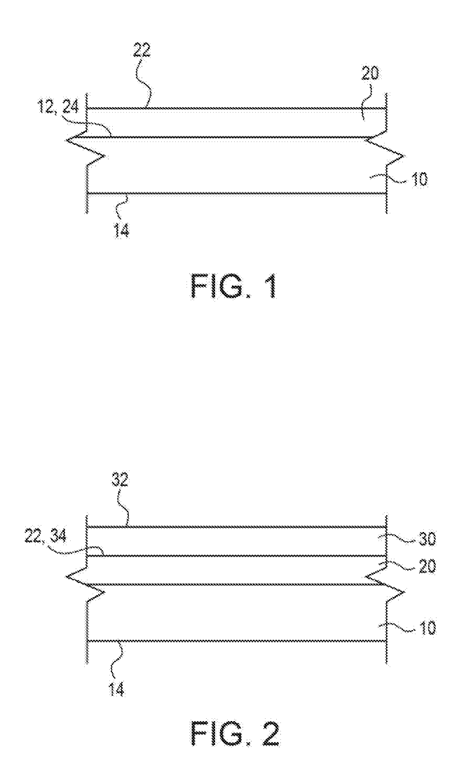

FIGS. 1-3 schematically illustrate representative cross sectional views of coated substrates in accordance with the present subject matter. FIG. 1 depicts a substrate 10 defining a first face 12 and an oppositely directed second face 14. A layer 20 of a coating composition, such as described herein for example, is disposed on the first face 12 of the substrate 10. The coating layer 20 defines first and second faces 22 and 24, respectively.

FIG. 2 depicts a substrate 10 having a coating layer 20 disposed thereon as described in conjunction with FIG. 1, and further including a covering layer 30 disposed on the face 22 of the coating layer 20. The covering layer defines first and second faces 32 and 34, respectively.

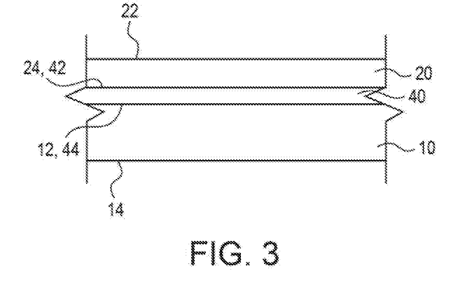

FIG. 3 depicts a substrate 10 having a coating layer 20 disposed thereon and further including an intermediate layer 40 positioned between the coating layer 20 and the substrate 10. The intermediate layer 40 defines first and second faces 42, 44 which extend immediately adjacent to face 24 of the coating layer 20 and face 12 of the substrate, respectively.

It will be appreciated that the present subject matter includes a wide array of variations of arrangements and types of layers and combinations of layers and in no way is limited to the embodiments of FIGS. 1-3.

The coating compositions of the present subject matter can be applied to substrates and in particular to PVC films to provide or improve one or more of the following aspects: increase opacity of the resulting coated substrate or film, improve durability of the resulting coated substrate or film, increase resistance to UV radiation of the resulting coated substrate or film, improve weather resistance of the resulting coated substrate or film, improve adhesion to the resulting coated substrate or film and particularly increase adhesive anchorage to the resulting coated film, and improve long term removability of the resulting coated substrate or film.

### EXAMPLES

Evaluations were conducted of film samples coated with opacifying compositions in accordance with the present subject matter. Table 4 set forth below summarizes various testing and evaluations of coated film samples designated as Samples 1-10.

TABLE 4
Summary of Samples 1-10

| | | | | | Total | Coating | | Coating | | OT | Cross- | | | | |
|---|---|---|---|---|---|---|---|---|---|---|---|---|---|---|---|
| | | | | Viscosity | Solids | Thickness | Contrast | Thickness | Opacity | Bend | Hatch | QUV | QUV | Accelerated | LTR |
| Sample | Film | Chemistry | Solvent Package | (CPS) | (%) | (mils) | Ratio | (mils) | (%) | Test | Anchorage | (hrs) | Comments | LTR | (hrs) |
| 1 | Orange | Platamid | IPA (40-50%) & | 650 ± 150 | 41.2 | | 83 | 0.60 | 89.28 | OK | 5 | 555 | Extreme | Marginal | 250 |
| | | | Toluene (10-11%) | | | | | | | | | | visual | | |
| | | | | | | | | | | | | | cracking | | |
| 2 | Orange | 70% acrylic + 30% vinyl- | n-Butyl acetate | 450 | | 0.55 | 89 | 0.65 | | OK | 3 | 1490 | Small | Fail | 750 |
| | | acrylic (copolymer with | (20-40%), Ethyl | | | | | | | | | | amount of | | |
| | | OH functionality) | acetate (20-40%), | | | | | | | | | | cracking | | |
| | | | Toluene (5-10%), | | | | | | | | | | seen only | | |
| | | | & PM acetate (1-5%) | | | | | | | | | | with | | |
| | | | | | | | | | | | | | magnification - | | |
| | | | | | | | | | | | | | observed | | |
| | | | | | | | | | | | | | 466 hrs | | |
| 3 | Orange | 70% acrylic + 30% vinyl- | n-Propyl acetate | 400 | | 0.55 | 90 | 0.75 | | OK | 4 | 1490 | No cracking | Marginal | 750 |
| | | acrylic (copolymer with | (20-40%), n-Butyl | | | | | | | | | | | | |
| | | COOH functionality) | acetate (20-40%), | | | | | | | | | | | | |
| | | | & Toluene (7-13%) | | | | | | | | | | | | |
| 4 | White | 70% vinyl-acrylic | Ethyl acetate | 400 | 36.7 | 0.50 | 85 | 0.50 | | OK* | 5 | 1480 | No cracking | Marginal | 1250 |
| | Pearl | (copolymer with OH | (28.5%), n-Butyl | | | | | | | | | | | | |
| | | functionality) + 30% | acetate (24.6%), | | | | | | | | | | | | |
| | | acrylic | Toluene (8.8%), | | | | | | | | | | | | |
| | | | PM acetate | | | | | | | | | | | | |
| | | | (1.0%), & Xylene | | | | | | | | | | | | |
| | | | (0.4%) | | | | | | | | | | | | |
| 5 | White | Polyester PU | IPA (30-60%) & | 600 | 43.0 | 0.50 | 87 | 0.58 | | OK | 5 | 1480 | No cracking | Marginal | 1250 |
| | Pearl | | Toluene (20-40%) | | | | | | | | | | | | |
| 6 | White | Alternate polyester PU | IPA (33.7%), | 1000 | 39.4 | 0.50 | 87 | 0.50 | | OK | 4 | 1480 | No cracking | Pass | 1250 |
| | Pearl | | Toluene (25.2%), | | | | | | | | | | | | |
| | | | PM acetate | | | | | | | | | | | | |
| | | | (1.3%), & Xylene | | | | | | | | | | | | |
| | | | (0.4%) | | | | | | | | | | | | |
| 7 | White | 70% vinyl-acrylic | n-Propyl acetate | 600 | 44.3 | 0.55 | 89 | 0.75 | | OK* | 5 | 1006 | No cracking | Marginal | 1000 |
| | Pearl | (copolymer with COOH | (21.2%), n-Butyl | | | | | | | | | | | | |
| | | functionality) + 30% | acetate (21.2%), | | | | | | | | | | | | |
| | | acrylic | Toluene (11.5%), | | | | | | | | | | | | |
| | | | PM acetate | | | | | | | | | | | | |
| | | | (1.3%), & Xylene | | | | | | | | | | | | |
| | | | (0.5%) | | | | | | | | | | | | |
| 8 | White | 100% vinyl-acrylic | Ethyl acetate (30-60%), | 500 | 32.0 | 0.50 | 85 | 0.62 | 90.05 | OK* | 4 | 262 | No cracking | Fail | 250 |
| | Pearl | (copolymer with OH | n-Butyl | | | | | | | | | | | | |
| | | functionality) | acetate (20-40%), | | | | | | | | | | | | |
| | | | & Toluene (3-8%) | | | | | | | | | | | | |
| 9 | White | Lower Tg acrylic (~ 30 C | Ethyl acetate | 400 | 36.5 | 0.50 | 86 | 0.66 | 90.08 | OK* | 4 | 262 | No cracking | Marginal | 250 |
| | Pearl | Tg) version of JR-9-148 | (28.5%), n-Butyl | | | | | | | | | | | | |
| | | | acetate (24.7%), | | | | | | | | | | | | |
| | | | Toluene (8.8%), | | | | | | | | | | | | |
| | | | PM acetate | | | | | | | | | | | | |
| | | | (1.0%), & Xylene | | | | | | | | | | | | |
| | | | (0.5%) | | | | | | | | | | | | |
| 10 | White | Softer urethane version | IPA (30-60%) & | 1100 | 45.0 | 0.50 | 96 | 0.70 | 92.59 | OK | 4 | 262 | No cracking | | 198 |
| | Pearl | of JKM-33-7105 | Toluene (20-40%) | | | | | | | | | | | | |

The values reported for QUV in Table 4 are the hours of direct exposure in QUV (ASTM G154-06 Cycle 4) before tie-coat cracking was observed.

For the OT Bend test, the designation “OK*” refers to some striations being observed but no cracking observed (under microscope). The designation “OK” refers to no striations and no cracking being observed.

The Cross Hatch Anchorage test is used to assess the resistance of paints, inks, and coatings to separate from the surface to which they are applied. Typically, that surface is a film. Generally, this method specifies a procedure for assessing the resistance of inks, paints, and other coatings to separation from substrates when a right-angle lattice pattern is cut into the coating, penetrating through to the substrate. The method may be used for a quick pass/fail test. When applied to a multi-coat system, assessment of the resistance to separation of individual layers of the coating/ink from each other may be made. Specifically, this evaluation is performed as follows. Each sample to be tested is placed on a smooth flat base to ensure adequate support. A cutter assembly is positioned on the test specimen. The cutter is a multiple tooth adhesion cutter as known in the art. The tips of the cutter first contact the test surface when the top of the handle is about 7° with respect to the test surface. This motion is continued until the top surface of the handle is elevated to about 15°. This is the correct attitude of the cutter for this test. With enough pressure on the handle to ensure that all of the cutter tips penetrate to the test specimen supporting base, the assembly is pulled along the test surface through 0.75 to 1.00 inch. This procedure is repeated with a second cut intersecting the first pattern at 90°. After making the required cuts, the surface is lightly brushed with a soft brush or tissue to remove any detached flakes or ribbons of coatings. Two complete laps of tape are removed and discarded. Remove about 3 inches of tape from the spool and place the center of the tape over the grid area and smooth down with finger (leave enough tape at end to fold over itself and create tab). To ensure good contact with the film/coating, the tape is rubbed firmly with an eraser or fingernail. The color under the tape is a useful indication of when good contact has been made. After 60 seconds, remove the tape by seizing the free end (tab) and rapidly but smoothly pulling it off at an angle of 180° as possible. The grid area is inspected for removal of coating/ink from the substrate or from a previous coating using an illuminated magnifier. Rate the adhesion in accordance with the following scale as described below. Repeat the test in two other locations on each test panel. Adhesion is rated according to the following scale. A rating of 5B means the edges of the cuts are completely smooth and none of the squares of the lattice is detached. A rating of 4B means small flakes of the coating are detached at intersections and less than 5% of the area is affected. A rating of 3B means small flakes of the coating are detached along the edges and at intersections of the cuts. The area affected is 5 to 15% of the lattice. A rating of 2B means the coating has flaked along the edges and on parts of the squares. The area affected is 15 to 35% of the lattice. A rating of 1B means the coating has flaked along the edges of cuts in large ribbons and whole squares have detached. The area affected is 35 to 65% of the lattice. And a rating of 0B means flaking and detachment worse than Grade 1.

The remaining properties and/or values reported in Table 4 are measured as described herein or as known to those skilled in the art.

The film samples evaluated and reported in Table 4 exhibit acceptable characteristics for a wide range of applications.

Another set of evaluations were performed to investigate other film samples coated with opacifying compositions in accordance with the present subject matter. Table 5 set forth below summarizes testing results of coated film samples designated as Samples A-K.

TABLE 5
Summary of Samples A-L

| | Sample | | | | | | | | | | |
|---|---|---|---|---|---|---|---|---|---|---|---|
| | Color | | | | | | | | | | |
| | A - | B - | C - | D - | E - | F - | G - | H - | I - | J - | K - |
| | Red | Blue | Red | Blue | Silver | Red | Blue | Silver | Red | Blue | Silver |
| Property | Metallic | Pearl | Metallic | Pearl | Metallic | Metallic | Pearl | Metallic | Metallic | Pearl | Metallic |
| Tg of tie-coat (° C.) - Vinyl-acrylic | 72.43 | | 75.68 | | | | | | | | |
| copolymer phase (70%) | | | | | | | | | | | |
| Tg of tie-coat (° C.) - Acrylic | 116.23 | | 65.24 | | | | | | | | |
| phase (30%) | | | | | | | | | | | |
| Gloss, 20° | 82.4 | 86.9 | 80.74 | 88.6 | 88.9 | 84.6 | 86.2 | 91.0 | 75.58 | 79.16 | 77.56 |
| Gloss, 60° | 94.4 | 100.4 | 93.76 | 101.0 | 107.2 | 93.92 | 100.6 | 108.0 | 89.06 | 97.3 | 101 |
| Gloss, 85° | 100.0 | 100.0 | 100.0 | 100.0 | 99.9 | 100.0 | 99.96 | 100.0 | 99.5 | 99.3 | 99.4 |
| Opacity (%) | 98.96 | 99.65 | 99.07 | 99.70 | 99.73 | 99.16 | 99.62 | 99.86 | 98.42% | 99.23% | 99.89% |
| Color, L | 25.18 | 33.33 | 25.01 | 34.35 | 38.87 | 24.86 | 33.86 | 40.21 | 25.42 | 32.4 | 38.99 |
| Color, a | 48.36 | −8.13 | 48.53 | −9.12 | 1.90 | 48.71 | −8.51 | −1.50 | 57.65 | −7.68 | 1.22 |
| Color, b | 13.91 | −44.52 | 13.8 | −44.69 | −10.44 | 13.37 | −44.88 | −10.45 | 14.49 | −44.31 | −10.14 |
| Tensile @ 16% elongation | 3.44 | 3.20 | 3.15 | 2.95 | 2.92 | 5.69 | 5.21 | 4.72 | 4.39 | 5.01 | 4.72 |
| (ft. lbs), fresh | | | | | | | | | | | |
| Elongation (%), fresh | 251 | 330 | 240 | 342 | 245 | 228 | 290 | 230 | 246% | 318% | 230% |
| Tensile @ 16% elongation ( ), | 6.00 | 6.02 | 5.59 | 5.63 | 4.88 | 5.15 | 5.19 | 4.78 | 5.32 | 6.43 | 6.83 |
| heat aged | | | | | | | | | | | |
| Elongation (%), heat aged | 242% | 326% | 229% | 348% | 199% | 253% | 315% | 253% | 199% | 321% | 195% |
| Stress relaxation (lbs.) fresh | 1.08 | 1.00 | 0.76 | 0.72 | 0.96 | 1.46 | 1.24 | 1.18 | 0.88 | 0.92 | 0.92 |
| Stress relaxation (lbs.) heat aged | 1.47 | 1.46 | 1.28 | 1.22 | 1.14 | 1.43 | 1.44 | 1.20 | 0.99 | 1.16 | 1.25 |
| Shrinkage, cross direction (inches) | 0.007 | 0.007 | 0.008 | 0.008 | 0.007 | 0.006 | 0.006 | 0.006 | 0.006 | 0.006 | 0.006 |
| Shrinkage, machine direction (inches) | 0.008 | 0.008 | 0.008 | 0.008 | 0.008 | 0.007 | 0.006 | 0.006 | 0.006 | 0.006 | 0.008 |
| Corrugation performance, Sprinter | | | | | | | | | | | |
| van (sq. in.): | | | | | | | | | | | |
| (all are applied w/ heat & set) | | | | | | | | | | | |
| 24 hours | 0.022 | 0.000 | 0.000 | 0.000 | 0.000 | 0.000 | 0.050 | 0.064 | 0.000 | 0.000 | 0.000 |
| 250 hours in QUV | 0.898 | 0.479 | 0.383 | 0.391 | 0.307 | 0.807 | 0.381 | 0.697 | 0.000 | 0.000 | 0.000 |
| 500 hours in QUV | 1.000 | 1.000 | 0.680 | 0.370 | 0.296 | 1.000 | 0.384 | 0.694 | 0.000 | 0.000 | 0.000 |
| 750 hours in QUV | | | 0.387 | 0.390 | 0.315 | | 0.406 | 0.759 | 0.002 | 0.007 | 0.000 |
| 1000 hours in QUV | | | 0.387 | 0.390 | 0.320 | | 0.407 | 0.813 | 0.034 | 0.004 | 0.000 |
| Rivet conformability (inches): | | | | | | | | | | | |
| 24 hours | 0.143 | 0.134 | 0.145 | 0.156 | 0.104 | 0.128 | 0.126 | 0.124 | 0.093 | 0.084 | 0.063 |
| 250 hours in QUV | 0.165 | 0.156 | 0.169 | 0.168 | 0.122 | 0.150 | 0.144 | 0.140 | 0.124 | 0.111 | 0.115 |
| 500 hours in QUV | 0.180 | 0.164 | 0.166 | 0.177 | 0.138 | 0.156 | 0.150 | 0.148 | 0.144 | 0.128 | 0.130 |
| 750 hours in QUV | 0.180 | 0.164 | 0.166 | 0.177 | 0.138 | 0.156 | 0.150 | 0.148 | 0.136 | 0.110 | 0.129 |
| 1000 hours in QUV | 0.180 | 0.164 | 0.170 | 0.177 | 0.145 | 0.156 | 0.151 | 0.148 | 0.136 | 0.110 | 0.130 |
| QUV weathering (60° Gloss, | | | | | | | | | | | |
| Delta E) | | | | | | | | | | | |
| 0 hours | 93.9 | 99.2 | 93.2 | 101.0 | 107.7 | 93.7 | 101.0 | 107.7 | | 90.1 | 99.1 |
| 250 hours | 92.4, 3.08 | 102.0, | 93.7, | 100.4, | 108.0, | 91.8, 3.11 | 99.7, | 108.0, | | 88.4, | 97.3, 1.03 |
| | | 2.18 | 2.88 | 1.86 | 0.93 | | 2.18 | 1.27 | | 4.13 | |
| 500 hours | 93.8, 3.74 | 102.0, | 93.9, | 102.0, | 109.0, | 93.6, 4.15 | 100.0, | 109.0, | | 88.7, | 97.6, 1.14 |
| | | 2.38 | 3.69 | 1.97 | 0.86 | | 2.42 | 1.58 | | 4.74 | |
| 750 hours | 93.8, 4.94 | 102.7, | 90.2, | 102.0, | 107.3, | 93.2, 4.39 | 99.9, | 107.0, | | 88.3, | 98.4, 1.74 |
| | | 2.68 | 4.99 | 2.24 | 1.35 | | 2.78 | 1.52 | | 4.50 | |

Rivet conformability testing was performed as follows. This testing method uses 4 by 12 inch riveted painted aluminum test panels to which a film sample coated with an embodiment of an opacifying composition, and having a face of pressure sensitive adhesive is applied. The film samples are approximately 2.5 by 2.5 inches and are applied over two or more rivet(s) using a heat gun, rivet brush, and squeegee. Once applied, the sample is placed into a weatherometer. The sample is then subjected to artificial weathering and the sample is then monitored for signs of tenting or cracking.

Prior to adhering film sample(s) to the test panel, the panel is cleaned with isopropyl alcohol and wipes to remove any dirt, oil, or contaminants. Each sample is applied over at least two rivets with attention to machine direction and/or cross direction application.

After application of film samples to the test panel, if any air is trapped such as around rivet head(s), a pin is used to release the air. Heat is applied using a heat gun, around each rivet head. Typical heat application times are 2 to 3 seconds.

After film samples have been applied, the test panel and samples adhered thereto are subjected to a dwell period of 24 hours. A vernier caliper is used to measure initial tenting measurement.

Test panels are then in using a standard test cycle of 1,000 hours. Tenting is monitored and measured at 250, 500, 750, and 1,000 hours.

Many of the film samples evaluated and reported in Table 5 exhibited acceptable characteristics for a wide range of applications. Samples I, J, and K exhibit excellent properties.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A coating composition comprising at least one resin component and at least one opacifying agent, the resin component selected from the group consisting of:
(i) polyvinyl acrylate copolymer with —COOH functionality having a Tg within a range of from 20° C. to 80° C.,
(ii) polyvinyl acrylate copolymer with —OH functionality having a Tg within a range of from 20° C. to 80° C.,
(iii) polyester polyurethane having a softening point within a range of from 120° C. to 180° C.,
(iv) combination of polyvinyl acrylate copolymer with —COOH functionality with a Tg within a range of from 20° C. to 80° C. with acrylate(s) having a Tg within a range of from 20° C. to 80° C.,
(v) combination of polyvinyl acrylate copolymer with —OH functionality with a Tg within a range of from 20° C. to 80° C. with acrylate(s) having a Tg within a range of from 20° C. to 80° C., and
(vi) acrylate(s) having a Tg within a range of from 20° C. to 80° C.

2. The coating composition of claim 1 wherein the resin component is selected as (i).

3. The coating composition of claim 2 wherein the polyvinyl acrylate copolymer with —COOH functionality has a Tg within a range of from 65° C. to 80° C.

4. The coating composition of claim 1 wherein the resin component is selected as (ii).

5. The coating composition of claim 4 wherein the polyvinyl acrylate copolymer with —OH functionality has a Tg within a range of from 65° C. to 80° C.

6. The coating composition of claim 1 wherein the resin component is selected as (iii).

7. The coating composition of claim 1 wherein the resin component is selected as (iv).

8. The coating composition of claim 7 wherein the polyvinyl acrylate copolymer with —COOH functionality has a Tg within a range of from 65° C. to 80° C.

9. The coating composition of claim 7 wherein the acrylate(s) have a Tg of about 65° C.

10. The coating composition of claim 7 wherein the weight ratio of the polyvinyl acrylate copolymer to the acrylate(s) is within a range of from 20% to 80%.

11. The coating composition of claim 10 wherein the weight ratio is within a range of from 30% to 70%.

12. The coating composition of claim 1 wherein the resin component is selected as (v).

13. The coating composition of claim 12 wherein the polyvinyl acrylate copolymer with —OH functionality has a Tg within a range of from 65° C. to 80° C.

14. The coating composition of claim 12 wherein the acrylate(s) have a Tg of about 65° C.

15. The coating composition of claim 12 wherein the weight ratio of the polyvinyl acrylate copolymer to the acrylate(s) is within a range of from 20% to 80%.

16. The coating composition of claim 15 wherein the weight ratio is within a range of from 30% to 70%.

17. The coating composition of claim 1 wherein the resin component is selected as (vi).

18. The coating composition of claim 17 wherein the acrylate(s) have a Tg within a range of from 35° C. to 65° C.

19. The coating composition of claim 1 wherein the opacifying agent is selected from the group consisting of titanium dioxide, calcium carbonate, and combinations thereof.

20. The coating composition of claim 19 wherein the opacifying agent includes titanium dioxide.

21. The coating composition of claim 20 wherein the titanium dioxide has an average particle size within a range of from 300 nm to 8 microns.

22. The coating composition of claim 21 wherein the titanium dioxide has an average particle size within a range of from 500 nm to 1.5 micron.

23. The coating composition of claim 20 wherein the titanium dioxide is produced by a chloride process.

24. The coating composition of claim 20 wherein the composition is free of titanium dioxide produced by a sulfate process.

25. The coating composition of claim 20 wherein the titanium dioxide is in the form of core-shell particles that include a shell having at least one of silicon oxide and aluminum oxide.

26. The coating composition of claim 19 wherein the opacifying agent includes calcium carbonate.

27. The coating composition of claim 19 wherein the opacifying agent includes titanium dioxide and calcium carbonate.

28. The coating composition of claim 1 further comprising at least one solvent.

29. The coating composition of claim 28 wherein the at least one solvent is selected from the group consisting of alkyl acetate solvents, ketone solvents, alcohol solvents, benzene derivative solvents, and combinations thereof.

30. The coating composition of claim 29 wherein the solvent includes an alkyl acetate solvent selected from the group consisting of ethyl acetate, n-propyl acetate, butyal acetate, n-butyl acetate, propylene glycol monomethyl ether acetate, methoxypropyl acetate, and combinations thereof.

31. The coating composition of claim 29 wherein the solvent includes a ketone solvent which is methyl ethyl ketone.

32. The coating composition of claim 29 wherein the solvent includes an alcohol solvent which is isopropyl alcohol.

33. The coating composition of claim 29 wherein the solvent includes a benzene derivative solvent and is selected from the group consisting of toluene, xylene, and combinations thereof.

34. The coating composition of claim 29 wherein the solvent is a solvent system including:
20% to 36% ethyl acetate,
18% to 30% n-butyl acetate,
4% to 12% toluene,
0.1% to 5% propylene glycol monomethyl ether acetate, and
0.1% to 2% xylene.

35. The coating composition of claim 29 wherein the solvent is a solvent system including:
20% to 45% isopropyl alcohol,
15% to 35% toluene,
0.1% to 5% propylene glycol monomethyl ether acetate, and
0.1% to 2% xylene.

36. The coating composition of claim 29 wherein the solvent is a solvent system including:
15% to 28% n-propyl acetate,
15% to 28% n-butyl acetate,
5% to 15% toluene,
0.1% to 5% propylene glycol monomethyl ether acetate,
0.1% to 2% xylene.

37. The coating composition of claim 1 further comprising at least one processing agent.

38. The coating composition of claim 37 wherein the processing agent is selected from the group consisting of dispersants, wetting agents, thickening agents, drying aids, and combinations thereof.

39. The coating composition of claim 37 wherein the total amount of the processing agents in the composition is within a range of from 0.05% to 2.0%.

40. A method of producing a coated polymeric film, the method comprising:
providing a polymeric film to be coated;
providing a coating composition comprising at least one resin component, at least one solvent, and at least one opacifying agent, the resin component selected from the group consisting of (i) polyvinyl acrylate copolymer with —COOH functionality having a Tg within a range of from 20° C. to 80° C., (ii) polyvinyl acrylate copolymer with —OH functionality having a Tg within a range of from 20° C. to 80° C., (iii) polyester polyurethane having a softening point within a range of from 120° C. to 180° C., (iv) combination of polyvinyl acrylate copolymer with —COOH functionality with a Tg within a range of from 20° C. to 80° C. with acrylate(s) having a Tg within a range of from 20° C. to 80° C., (v) combination of polyvinyl acrylate copolymer with —OH functionality with a Tg within a range of from 20° C. to 80° C. with acrylate(s) having a Tg within a range of from 20° C. to 80° C., and (vi) acrylate(s) having a Tg within a range of from 20° C. to 80° C.;
applying the coating composition to the film; and
drying the applied coating composition to thereby produce a coated polymeric film.

41. The method of claim 40 wherein the coating composition includes a majority weight proportion of solvent.

42. The method of claim 40 wherein drying is performed by heating the applied coating composition to a temperature within a range of from 200° F. (93° C.) to 300° F. (149° C.).

43. The method of claim 40 wherein drying is performed until an amount of residual solvent in the coating composition is less than 2.0%.

44. The method of claim 40 wherein drying is performed so that the dried coating weight is within a range of from 10 gsm to 25 gsm.

45. The method of claim 40 wherein the resin component is selected as (i).

46. The method of claim 45 wherein the polyvinyl acrylate copolymer with —COOH functionality has a Tg within a range of from 65° C. to 80° C.

47. The method of claim 40 wherein the resin component is selected as (ii).

48. The method of claim 47 wherein the polyvinyl acrylate copolymer with —OH functionality has a Tg within a range of from 65° C. to 80° C.

49. The method of claim 40 wherein the resin component is selected as (iii).

50. The method of claim 40 wherein the resin component is selected as (iv).

51. The method of claim 50 wherein the polyvinyl acrylate copolymer with —COOH functionality has a Tg within a range of from 65° C. to 80° C.

52. The method of claim 50 wherein the acrylate(s) have a Tg of about 65° C.

53. The method of claim 50 wherein the weight ratio of the polyvinyl acrylate copolymer to the acrylate(s) is within a range of from 20% to 80%.

54. The method of claim 53 wherein the weight ratio is within a range of from 30% to 70%.

55. The method of claim 40 wherein the resin component is selected as (v).

56. The method of claim 55 wherein the polyvinyl acrylate copolymer with —OH functionality has a Tg within a range of from 65° C. to 80° C.

57. The method of claim 55 wherein the acrylate(s) have a Tg of about 65° C.

58. The method of claim 55 wherein the weight ratio of the polyvinyl acrylate copolymer to the acrylate(s) is within a range of from 20% to 80%.

59. The method of claim 58 wherein the weight ratio is within a range of from 30% to 70%.

60. The method of claim 40 wherein the resin component is selected as (vi).

61. The method of claim 60 wherein the acrylate(s) have a Tg within a range of from 35° C. to 65° C.

62. The method of claim 40 wherein the opacifying agent is selected from the group consisting of titanium dioxide, calcium carbonate, and combinations thereof.

63. The method of claim 62 wherein the opacifying agent includes titanium dioxide.

64. The method of claim 63 wherein the titanium dioxide has an average particle size within a range of from 300 nm to 8 microns.

65. The method of claim 64 wherein the titanium dioxide has an average particle size within a range of from 500 nm to 1.5 micron.

66. The method of claim 63 wherein the titanium dioxide is produced by a chloride process.

67. The method of claim 63 wherein the composition is free of titanium dioxide produced by a sulfate process.

68. The method of claim 63 wherein the titanium dioxide is in the form of core-shell particles that include a shell having at least one of silicon oxide and aluminum oxide.

69. The method of claim 62 wherein the opacifying agent includes calcium carbonate.

70. The method of claim 62 wherein the opacifying agent includes titanium dioxide and calcium carbonate.

71. The method of claim 40 wherein the film is polyvinyl chloride.

72. The method of claim 40 wherein the at least one solvent is selected from the group consisting of alkyl acetate solvents, ketone solvents, alcohol solvents, benzene derivative solvents, and combinations thereof.

73. The method of claim 72 wherein the solvent includes an alkyl acetate solvent selected from the group consisting of ethyl acetate, n-propyl acetate, butyal acetate, n-butyl acetate, propylene glycol monomethyl ether acetate, methoxypropyl acetate, and combinations thereof.

74. The method of claim 72 wherein the solvent includes a ketone solvent which is methyl ethyl ketone.

75. The method of claim 72 wherein the solvent includes an alcohol solvent which is isopropyl alcohol.

76. The method of claim 72 wherein the solvent includes a benzene derivative solvent and is selected from the group consisting of toluene, xylene, and combinations thereof.

77. The method of claim 72 wherein the solvent is a solvent system including:
20% to 36% ethyl acetate,
18% to 30% n-butyl acetate,
4% to 12% toluene,
0.1% to 5% propylene glycol monomethyl ether acetate, and
0.1% to 2% xylene.

78. The method of claim 72 wherein the solvent is a solvent system including:
20% to 45% isopropyl alcohol,
15% to 35% toluene,
0.1% to 5% propylene glycol monomethyl ether acetate, and
0.1% to 2% xylene.

79. The method of claim 72 wherein the solvent is a solvent system including:
15% to 28% n-propyl acetate,
15% to 28% n-butyl acetate,
5% to 15% toluene,
0.1% to 5% propylene glycol monomethyl ether acetate,
0.1% to 2% xylene.

80. The method of claim 40 further comprising at least one processing agent.

81. The method of claim 80 wherein the processing agent is selected from the group consisting of dispersants, wetting agents, thickening agents, drying aids, and combinations thereof.

82. The method of claim 80 wherein the total amount of the processing agents in the composition is within a range of from 0.05% to 2.0%.

83. A coated film produced by the method of claim 40.

84. The coated film of claim 83 wherein the coating is substantially noncrosslinked.

85. The coated film of claim 83 wherein the coating is crosslinked.

86. A coated substrate comprising:
a substrate; and
a layer of a coating composition disposed on the substrate, wherein the coating composition includes at least one resin component and at least one opacifying agent, the resin component selected from the group consisting of (i) polyvinyl acrylate copolymer with —COOH functionality having a Tg within a range of from 20° C. to 80° C., (ii) polyvinyl acrylate copolymer with —OH functionality having a Tg within a range of from 20° C. to 80° C., (iii) polyester polyurethane having a softening point within a range of from 120° C. to 180° C., (iv) combination of polyvinyl acrylate copolymer with —COOH functionality with a Tg within a range of from 20° C. to 80° C. with acrylate(s) having a Tg within a range of from 20° C. to 80° C., (v) combination of polyvinyl acrylate copolymer with —OH functionality with a Tg within a range of from 20° C. to 80° C. with acrylate(s) having a Tg within a range of from 20° C. to 80° C., and (vi) acrylate(s) having a Tg within a range of from 20° C. to 80° C.

87. The coated substrate of claim 86 wherein the substrate is a polymeric film.

88. The coated substrate of claim 87 wherein the polymeric film is selected from the group consisting of polyurethanes, polyethylenes, polypropylenes, polyesters, polyether esters, polyacrylates, polyvinyl chloride, and combinations thereof.

89. The coated substrate of claim 88 wherein the polymeric film is polyvinyl chloride.

90. The coated substrate of claim 86 wherein the coating weight of the layer of the coating composition is within a range of from 10 gsm to 25 gsm.

91. The coated substrate of any of claim 86 wherein the resin component is selected as (i).

92. The coated substrate of claim 91 wherein the polyvinyl acrylate copolymer with —COOH functionality has a Tg within a range of from 65° C. to 80° C.

93. The coated substrate of claim 86 wherein the resin component is selected as (ii).

94. The coated substrate of claim 93 wherein the polyvinyl acrylate copolymer with —OH functionality has a Tg within a range of from 65° C. to 80° C.

95. The coated substrate of claim 86 wherein the resin component is selected as (iii).

96. The coated substrate of claim 86 wherein the resin component is selected as (iv).

97. The coated substrate of claim 96 wherein the polyvinyl acrylate copolymer with —COOH functionality has a Tg within a range of from 65° C. to 80° C.

98. The coated substrate of claim 96 wherein the acrylate(s) have a Tg of about 65° C.

99. The coated substrate of claim 96 wherein the weight ratio of the polyvinyl acrylate copolymer to the acrylate(s) is within a range of from 20% to 80%.

100. The coated substrate of claim 96 wherein the weight ratio is within a range of from 30% to 70%.

101. The coated substrate of claim 86 wherein the resin component is selected as (v).

102. The coated substrate of claim 101 wherein the polyvinyl acrylate copolymer with —OH functionality has a Tg within a range of from 65° C. to 80° C.

103. The coated substrate of claim 101 wherein the acrylate(s) have a Tg of about 65° C.

104. The coated substrate of claim 101 wherein the weight ratio of the polyvinyl acrylate copolymer to the acrylate(s) is within a range of from 20% to 80%.

105. The coated substrate of claim 104 wherein the weight ratio is within a range of from 30% to 70%.

106. The coated substrate of claim 86 wherein the resin component is selected as (vi).

107. The coated substrate of claim 106 wherein the acrylate(s) have a Tg within a range of from 35° C. to 65° C.

108. The coated substrate of claim 86 wherein the opacifying agent is selected from the group consisting of titanium dioxide, calcium carbonate, and combinations thereof.

109. The coated substrate of claim 108 wherein the opacifying agent includes titanium dioxide.

110. The coated substrate of claim 109 wherein the titanium dioxide has an average particle size within a range of from 300 nm to 8 microns.

111. The coated substrate of claim 110 wherein the titanium dioxide has an average particle size within a range of from 500 nm to 1.5 micron.

112. The coated substrate of claim 109 wherein the titanium dioxide is produced by a chloride process.

113. The coated substrate of claim 109 wherein the composition is free of titanium dioxide produced by a sulfate process.

114. The coated substrate of claim 109 wherein the titanium dioxide is in the form of core-shell particles that include a shell having at least one of silicon oxide and aluminum oxide.

115. The coated substrate of claim 108 wherein the opacifying agent includes calcium carbonate.

116. The coated substrate of claim 108 wherein the opacifying agent includes titanium dioxide and calcium carbonate.

117. The coated substrate of claim 86 further comprising at least one solvent.

118. The coated substrate of claim 117 wherein the at least one solvent is selected from the group consisting of alkyl acetate solvents, ketone solvents, alcohol solvents, benzene derivative solvents, and combinations thereof.

119. The coated substrate of claim 118 wherein the solvent includes an alkyl acetate solvent selected from the group consisting of ethyl acetate, n-propyl acetate, butyal acetate, n-butyl acetate, propylene glycol monomethyl ether acetate, methoxypropyl acetate, and combinations thereof.

120. The coated substrate of claim 118 wherein the solvent includes a ketone solvent which is methyl ethyl ketone.

121. The coated substrate of claim 118 wherein the solvent includes an alcohol solvent which is isopropyl alcohol.

122. The coated substrate of claim 118 wherein the solvent includes a benzene derivative solvent and is selected from the group consisting of toluene, xylene, and combinations thereof.

123. The coated substrate of claim 118 wherein the solvent is a solvent system including:
20% to 36% ethyl acetate,
18% to 30% n-butyl acetate,
4% to 12% toluene,
0.1% to 5% propylene glycol monomethyl ether acetate, and
0.1% to 2% xylene.

124. The coated substrate of claim 118 wherein the solvent is a solvent system including:
20% to 45% isopropyl alcohol,
15% to 35% toluene,
0.1% to 5% propylene glycol monomethyl ether acetate, and
0.1% to 2% xylene.

125. The coated substrate of claim 118 wherein the solvent is a solvent system including:
15% to 28% n-propyl acetate,
15% to 28% n-butyl acetate,
5% to 15% toluene,
0.1% to 5% propylene glycol monomethyl ether acetate,
0.1% to 2% xylene.

126. The coated substrate of claim 86 wherein the coating contains less than 2.0% of solvent.

127. The coated substrate of claim 86 further comprising at least one processing agent.

128. The coated substrate of claim 127 wherein the processing agent is selected from the group consisting of dispersants, wetting agents, thickening agents, drying aids, and combinations thereof.

129. The coated substrate of claim 127 wherein the total amount of the processing agents in the composition is within a range of from 0.05% to 2.0%.
